(19) United States
(12) Patent Application Publication
(10) Pub. No.: US 2014/0347559 A1
(43) Pub. Date: Nov. 27, 2014

(54) VIDEO DISPLAY APPARATUS

(71) Applicants: Masafumi Nishi, Moriguchi-shi (JP); Tsuyoshi Hasegawa, Moriguchi-shi (JP); Takafumi Hayashi, Moriguchi-shi (JP)

(72) Inventors: Masafumi Nishi, Moriguchi-shi (JP); Tsuyoshi Hasegawa, Moriguchi-shi (JP); Takafumi Hayashi, Moriguchi-shi (JP)

(73) Assignee: SANYO Electric Co., Ltd., Moriguchi-shi, Osaka (JP)

(21) Appl. No.: 14/345,209

(22) PCT Filed: Dec. 28, 2011
(86) PCT No.: PCT/JP2011/080402

§ 371 Date: Mar. 14, 2014

(51) Int. Cl. H04N 21/426; H04N 21/436; H04N 21/485; H04N 21/4363

(52) U.S. Cl. CPC H04N 21/42607; H04N 21/4363; H04N 21/43635; H04N 21/43615; H04N 21/485
USPC 348/555

(57) ABSTRACT

A video display device is provided with: an insertion section that enables direct insertion of a specified external device that outputs a video stream; and a control section. An input terminal is provided in the insertion section, said input terminal being for inputting the video stream output by the specified external device. The video display device has multiple choices as choices for an ‘item to input’, said multiple choices including a choice corresponding to the input terminal When the specified external device is inserted in the insertion section, the control section sets the ‘item to input’ to the choice corresponding to the input terminal.

### Technical Field

The present invention relates to an video display apparatus that includes an external input terminal for inputting an video stream from outside.

### Background Art

Video display apparatuses such as a television receiver and the like include a function for displaying an video based on an video stream that is produced by internal circuits such as a broadcast tuber and the like, besides, usually include an external input terminal for inputting an video stream from outside, and also include a function for displaying an video based on the video stream from outside. Besides, it is a general structure in which the video display apparatus is provided with a plurality of external input terminals.

### CITATION LIST

### Patent Literature

PLT1: JP-A-2006-217116

PLT1: JP-A-2008-53814

PLT1: JP-A-1997-83881

### SUMMARY OF INVENTION

### Technical Problem

In a case where an external device for outputting an video stream is used and an video is displayed on an video display apparatus based on the video stream from the external device, conventionally, it is necessary that an output terminal of the external apparatus for outputting the video stream and an external input terminal of the video display apparatus are connected to each other over a data transmission cable and a power supply terminal of the external device and a commercial power supply outlet are connected to each other over a power supply cord. In other words, it is time-consuming to install the external device that outputs the video stream.

Besides, conventionally, an input switchover of the video display apparatus is performed by a user operating an “input switching key” of a remote control transmitter or by the user operating an “upper key” or a “lower key” of the remote control transmitter in a state where a menu screen for switching the input of the video display apparatus is displayed, which is onerous for the user.

### Solution to Problem

An video display apparatus according to the present invention comprises: an insertion portion enables direct insertion of a specific external device that outputs an video stream, and a control portion, wherein the insertion portion is provided with an input terminal for inputting the video stream output from the specific external device; as choices for an “input target,” a plurality of choices including a choice corresponding to the input terminal are included; and when the specific external device is inserted into the insertion portion, the control portion sets the choice corresponding to the input terminal as the “input target.”

### Advantageous Effects of Invention

According to the video display apparatus of the present invention, it is easy to connect to the specific external device and it is not time-consuming to switch the input to the specific external device.

The significance and advantages of the present invention will be more apparent from the embodiment described below. Here, the following embodiment is an embodiment of the present invention and the present invention and the meaning of a term of each constituent element are not limited to those described in the following embodiment.

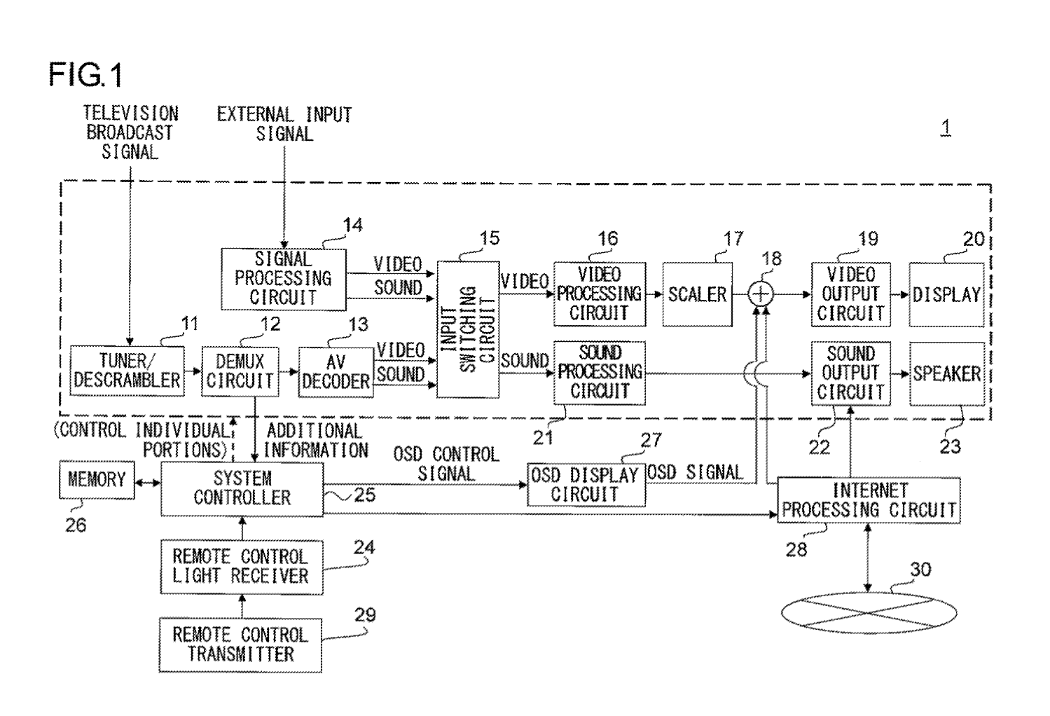

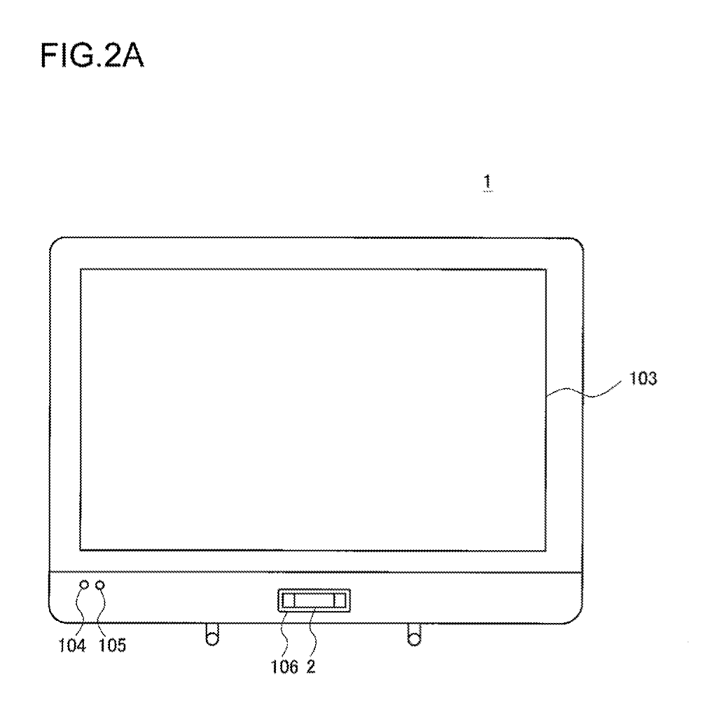

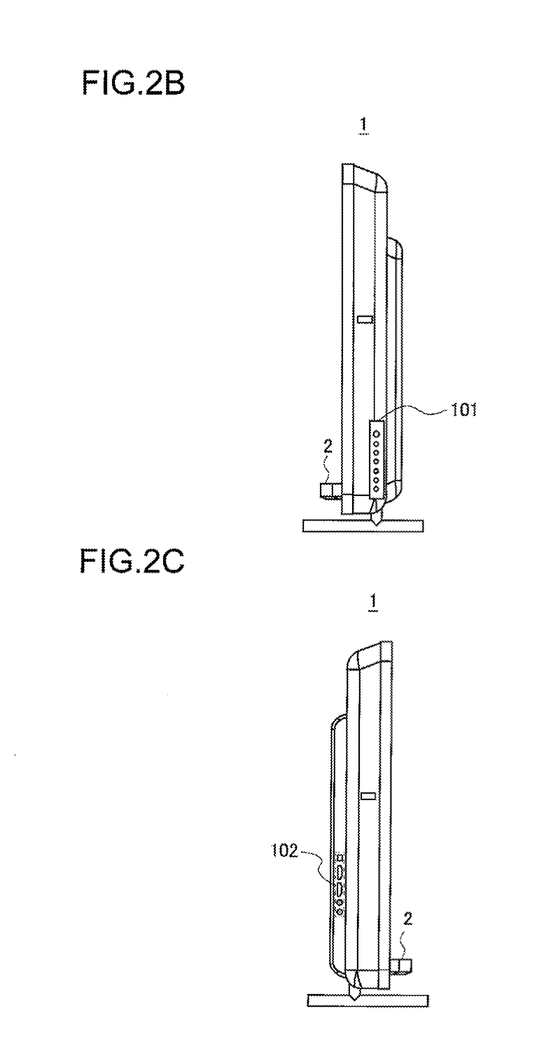

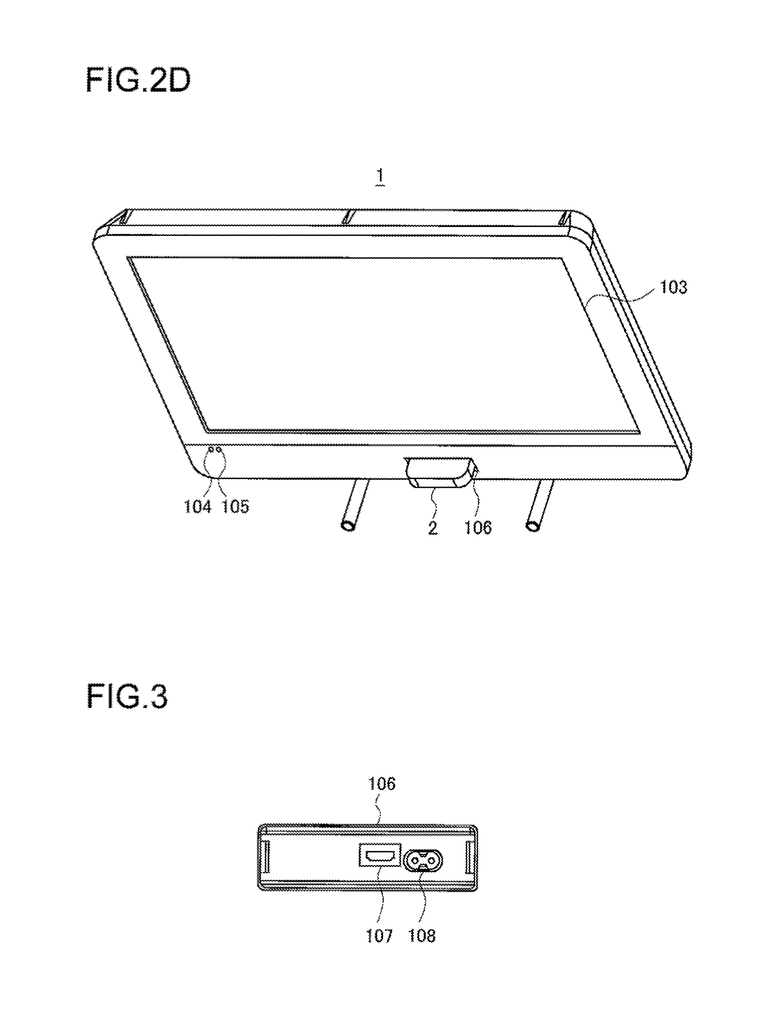

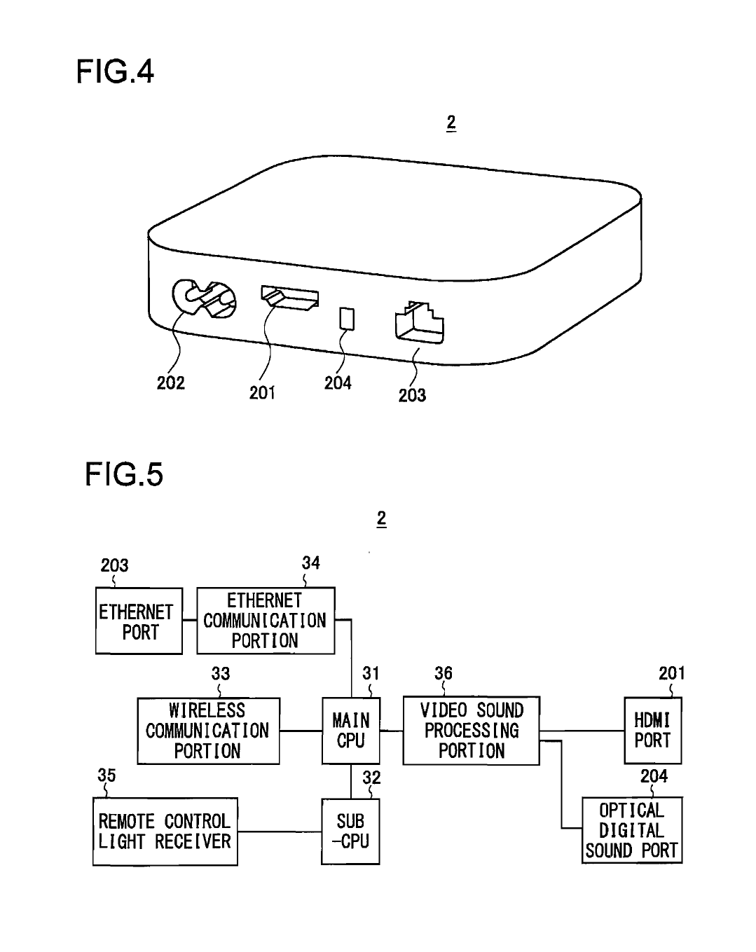

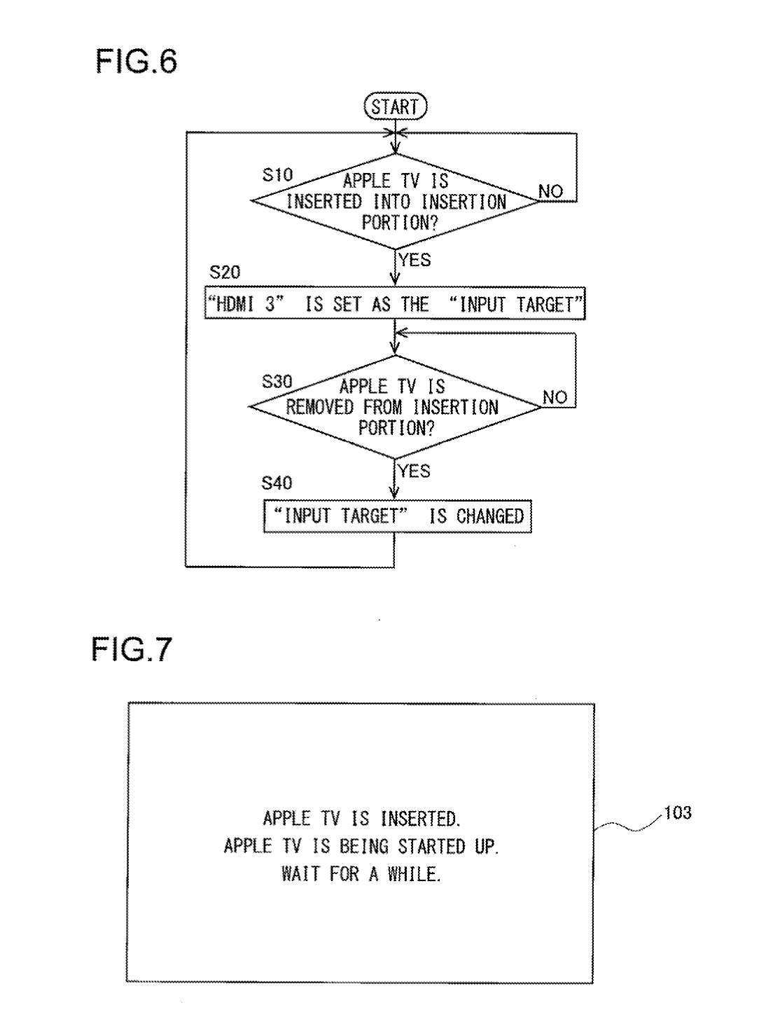

### BRIEF DESCRIPTION OF DRAWINGS

[FIG. 1] is a block diagram of an video display apparatus according to an embodiment of the present invention.

[FIG. 2A] is a front view of an video display apparatus according to an embodiment of the present invention.

[FIG. 2B] is a right side view of an video display apparatus according to an embodiment of the present invention.

[FIG. 2C] is a left side view of an video display apparatus according to an embodiment of the present invention.

[FIG. 2D] is a perspective view of an video display apparatus according to an embodiment of the present invention.

[FIG. 3] is a view showing an insertion portion that is disposed in a front lower portion of an video display apparatus according to an embodiment of the present invention.

[FIG. 4] is a perspective view in a case of seeing from a rear surface of Apple TV (registered trademark of Apple Inc.).

[FIG. 5] is a block diagram of Apple TV.

[FIG. 6] is a flow chart showing operation of an video display apparatus according to an embodiment of the present invention relevant to a characterizing portion of the present invention.

[FIG. 7] is a view showing a display screen example of an video display apparatus according to an embodiment of the present invention.

### DESCRIPTION OF EMBODIMENTS

An embodiment of the present invention is described hereinafter with reference to the drawings.

FIG. 1 is a block diagram of an video display apparatus 1 according to the embodiment of the present invention. The video display apparatus 1 according to the embodiment of the present invention is a television receiver that has an internet connection function, and as shown in FIG. 1, includes: a tuner/descrambler 11; a DEMUX circuit 12; an AV decoder 13; a signal processing circuit 14; an input switching circuit 15; an video processing circuit 16; a scaler 17; a complex circuit 18; an video output circuit 19; a display 20; a sound processing circuit 21; a sound output circuit 22; a speaker 23; a remote control light receiver 24; a system controller 25; a memory 26; an OSD [On-Screen Display] display circuit 27; and an internet processing circuit 28. A remote control transmitter 29 is a device that comes with the video display apparatus 1 according to the embodiment of the present invention. A user can remotely operate the video display apparatus 1 according to the embodiment by operating the remote control transmitter 29.

In the meantime, the video display apparatus 1 according to the embodiment of the present invention has, as choices for an “input target,” “digital terrestrial broadcasting,” “digital satellite broadcasting,” “HDMI [High Definition Multimedia Interface] 1,” “HDMI 2,” and “HDMI 3.”

The tuner/descrambler 11 applies a process (channel selection process) for extracting a signal corresponding to an “input target” set presently and a “reception channel,” a predetermined high-frequency process, an unscrambling process, a demodulation process and the like to a television broadcast signal that is transmitted from an antenna and the like. Signals obtained by these operations are output as a packet to DEMUX circuit 12. In the meantime, the “input target” and the “reception channel” are switchable by the system controller 25.

The DEMUX circuit 12 decodes the packet received from the tuner/descrambler 11. Here, the packet is divided by the DEMUX circuit 12 into: MPEG data that indicates content of a television program; and additional information. And, the MPEG data including an video stream and a sound stream is output to the AV decoder 13 and the additional information is output to the system controller 25. In the meantime, the additional information is, for example, guidance information of a television program that is presently broadcasted or is scheduled to be broadcasted in the future, or information such as notification from a broadcasting company and the like that is broadcasted together with the content of the television program at predetermine time intervals.

The AV decoder 13 decodes the MPEG data received from the DEMUX circuit 12 into an video signal and a sound signal, and outputs the video signal and the sound signal to the input switching circuit 15.

Based on an external input signal (video stream and sound stream) corresponding to the “input target” that is presently set, the signal processing circuit 14 obtains an video signal and a sound signal that indicate contents. The signal processing circuit 14 outputs the obtained video signal and sound signal to the input switching circuit 15.

The input switching circuit 15 transmits an video signal and sound signal only, which are signals of the video signals and sound signals transmitted from the pre-stage and correspond to the “input target,” to the post-stage circuit.

In other words, when the “digital terrestrial broadcasting” or the “digital satellite broadcasting” is set as the “input target,” the input switching circuit 15 transmits the video signal and sound signal transmitted from the AV decoder 13 to the video processing circuit 16 and the sound processing circuit 21, respectively. On the other hand, when the “HDMI 1,” the “HDMI 2,” or the “HDMI 3” is set as the “input target,” the input switching circuit 15 transmits the video signal and sound signal transmitted from the signal processing circuit 14 to the video processing circuit 16 and the sound processing circuit 21, respectively.

Besides, the video processing circuit 16 applies various processes to the video signal received from the input switching circuit 15 and outputs the processed video signal to the scaler 17. The processes performed by the video processing circuit 16 include various video-quality adjustment processes (e.g., contrast adjustment, brightness adjustment, sharpness adjustment and the like).

In accordance with an instruction from the system controller 25, the scaler 17 outputs the video signal received from the video processing circuit 16 to the complex circuit 18 as it is. Or, the scaler 17 applies a process (video small-sizing process) to the video signal received from the video processing circuit 16 such that the video is small-sized and displayed, and outputs the processed video signal to the complex circuit 18.

The complex circuit 18 receives the video signal from the scaler 17, an OSD signal from the OSD display circuit 27, and an video signal of internet contents from the internet processing circuit 28, and outputs any one of these signals to the video output circuit 19, or generates a display signal, which indicates composite (combined) content of contents of at least two signals of these signals, and outputs the display signal to the video output circuit 19.

The video output circuit 19 outputs the received display signal to the display 20 such that the content of the display signal is displayed on the display 20. In the meantime, as the display 20, various displays such as, for example, a CRT [Cathode Ray Tube], a liquid crystal display and the like, are employable.

The sound processing circuit 21 applies a necessary predetermined process to the sound signal received from the input switching circuit 15 and outputs the processed sound signal to the sound output circuit 22. The sound output circuit 22 outputs the received sound signal to the speaker 23 such that the sound based on the sound signal is output from the speaker 23.

The remote control light receiver 24 receives an infrared signal transmitted from the remote control transmitter 29, transduces the infrared signal into an electric signal, and transmits the electric signal to the system controller 25.

In accordance with user's operations on a plurality of kinds of operation keys (not shown in FIG. 1) disposed on the video display apparatus 1 according to the embodiment of the present invention or on a plurality of kinds of operation keys disposed on the remote control transmitter 29, the system controller 25 controls each portion of the video display apparatus 1 according to the embodiment of the present invention. The memory 26 stores information such as various kinds of OSD display screen data and the like.

The OSD display circuit 27 receives from the system controller 25 an OSD control signal that includes the OSD display screen data, generates an OSD signal based on this control signal, and outputs the OSD signal to the complex circuit 18.

The internet processing circuit 28 has a function for connecting to the internet 30, receives internet contents from a predetermined server via the internet 30, outputs an video signal of the internet contents to the complex circuit 18, and outputs a sound signal of the internet contents to the sound output circuit 22.

FIG. 2A, FIG. 2B, FIG. 2C, and FIG. 2D are respectively a front view, a right side view when seeing from the front, a left side view when seeing from the front, and a perspective view of the video display apparatus 1 according to the embodiment of the present invention. In the meantime, FIG. 2A, FIG. 2B, FIG. 2C, and FIG. 2D each show a state in which an Apple TV 2 is inserted in a front lower portion of the video display apparatus 1 according to the embodiment of the present invention.

As shown in FIG. 2B, an operation portion 101 is disposed in a right-side lower portion in a case of seeing from the front of the video display apparatus 1 according to the embodiment of the present invention. The operation portion 101 includes a power supply switch for switching power supply ON/OFF of the video display apparatus 1 according to the embodiment of the present invention.

As shown in FIG. 2C, a terminal portion 102 is disposed in a left-side rear portion in the case of seeing from the front of the video display apparatus 1 according to the embodiment of the present invention. The terminal portion 102 includes: an HDMI terminal corresponding to “HDMI 1” that is one of the choices for the “input target”; an HDMI terminal corresponding to “HDMI 2” that is one of the choices for the “input target”; an antenna terminal for antenna connection; and a LAN [Local Area Network] terminal for the internet connection.

As shown in FIG. 2A and FIG. 2D, the front of the video display apparatus 1 according to the embodiment of the present invention is provided with: a display screen 103 of the display 20 (see FIG. 1); a light reception surface 104 of the remote control light receiver 24 (see FIG. 1); and a power supply lamp 105. The power supply lamp 105 brightens greenly when the video display apparatus 1 according to the embodiment of the present invention is in an power supply ON state, brightens redly when the video display apparatus 1 according to the embodiment of the present invention is in a standby state, and goes out when the video display apparatus 1 according to the embodiment of the present invention is in an power supply OFF state. In the meantime, a switchover among the power supply ON state, the standby state, and the power supply OFF state is possible by operation of the power supply switch included in the operation portion 101 (see FIG. 2B), while a switchover between the power supply ON state and the standby state is possible by operation of the power supply key included in the remote control transmitter 29 (see FIG. 1).

And, the front lower portion of the video display apparatus 1 according to the embodiment of the present invention is provided with an insertion portion 106 into which the Apple TV2 is directly insertable as shown in FIG. 2A and FIG. 2D. As shown in FIG. 3, the insertion portion 106 includes: an HDMI terminal 107 corresponding to the “HDMI 3” that is one of the choices for the “input target”; and an AC power supply terminal 108. The AC power supply terminal 108 is a terminal that outputs a commercial power supply voltage (e.g., 100 VAC in Japan), which the video display apparatus 1 according to the embodiment of the present invention receives from a commercial power supply outlet via a power supply cord, to outside. As described above, the video display apparatus 1 according to the embodiment of the present invention includes the insertion portion 106 into which the Apple TV2 is directly insertable; accordingly, it is easy to connect to the Apple TV2.

Dispositions of the HDMI terminal 107 and AC power supply terminal 108 are designed such that when the Apple TV2 is inserted into the insertion portion 106, the HDMI terminal 107 of the insertion portion 106 and an HDMI port 201 (see FIG. 4) disposed on a rear surface of the Apple TV2 are connected to each other and the AC power supply terminal 108 of the insertion portion 106 and an AC power supply port 202 (see FIG. 4) disposed on the rear surface of the Apple TV2 are connected to each other. Accordingly, when the Apple TV2 is inserted into the insertion portion 106, the video display apparatus 1 according to the embodiment of the present invention and the Apple TV2 are connected to each other via HDMI, and further, the AC power supply terminal 108 of the insertion portion 106 and the AC power supply port 202 (see FIG. 4) disposed on the rear surface of the Apple TV2 are connected to each other, so that the AC power supply voltage is supplied from the video display apparatus 1 according to the embodiment of the present invention to the Apple TV2.

Here, FIG. 5 shows a block diagram of the Apple TV2. The Apple TV2 includes: a main CPU 31; a sub-CPU 32; a wireless communication portion 33 that performs wireless communication with a mobile terminal, a personal computer, a cloud server and the like obeying Bluetooth (registered trademark), Wi-Fi (registered trademark) and the like; an Ethernet communication portion 34 that performs cable communication with a personal computer and the like; an Ethernet port 203; a remote control light receiver 35; an video sound processing portion 36 that is composed of an HDMI transmission portion and a digital sound interface portion; an HDMI port 201; and an optical digital sound port 204.

The remote control light receiver 35 receives an infrared signal which is transmitted from a remote control transmitter that is used to operate the Apple TV2, transduces the infrared signal into an electric signal, and transmits the electric signal to the sub-CPU 32. The sub-CPU 32 controls operation of the main CPU 31 based on the electric signal received from the remote control light receiver 35.

The main CPU 31 obeys the control by the sub-CPU 32 to decode a signal, which is input from the Ethernet port 203 and received by the Ethernet communication portion 34, or a signal received by the wireless communication portion 33 into an video stream, a sound stream, still video data and the like, and outputs them to the video sound processing portion 36.

The video sound processing portion 36 outputs the video stream, the sound stream the still video data and the like received from the main CPU 31 to the HDMI port 201 in a form of TMDS [Transition Minimized Differential Signaling], transduces the sound stream received from the main CPU 31 into an optical sound signal, and outputs the optical sound signal to the optical digital sound port 204.

Next, signal lines used for the HDMI transmission are described. The signal lines used for the HDMI transmission are the following first to fifth signal lines.

The first signal line is a TMDS data signal line that is used to transmit sound-video data and an infoframe (information such as a data format of the sound-video data and the like) in the TMDS form from a source device (the Apple TV2 in the present embodiment) to a sync device (the video display apparatus 1 according to the embodiment of the present invention in the present embodiment) in a one-way direction.

The second signal line is a HPD [Hot Plug Detect] signal line that is mainly used to indicate a start timing of outputting the sound-video data from a source device to a sync device.

The third signal line is a DDC (Display Data Channel) signal line that is used to transmit unique information (vendor name, model number, acceptable resolution, HDMI terminal number and the like) of a sync device to a source device. Besides, the DDC signal line is also used for HDCP (High-bandwidth Digital Content Protection) authentication.

The fourth signal line is a DDC 5V signal line that is used to supply a power supply voltage 5 V from a source device to a sync device. In the meantime, a sync device has a hardware structure in which after the power supply voltage 5 V from a source device is supplied via the fourth signal line, a HPD signal is output to a HPD pin of the HDMI terminal

The fifth signal lien is a CEC signal line that is used to achieve a CEC (Consumer Electronics Control) function.

The CEC function is a function that enables bilateral-directional control between a source device and a sync device and is defined in the HDMI standards together with a protocol for the sound-video data output. Many electronic devices compatible with the CEC function are already put in the market. The CEC function enables a command transmission in a bilateral direction between a source device and a sync device; accordingly, both of one-to-one device control and one-to-a plurality of devices control are possible. The CEC standards define various functions; however, it is left to makers which function to achieve in a product.

Next, operation of the video display apparatus 1 according to the embodiment of the present invention relevant to a characterizing portion of the present invention is described with reference to a flow chart shown in FIG. 5.

The video display apparatus 1 according to the embodiment of the present invention goes to the power supply ON state to start operation of the flow chart shown in FIG. 5. In the meantime, even in the standby state, the video display apparatus 1 according to the embodiment of the present invention may start the operation of the flow chart shown in FIG. 5. In a case of starting the operation of the flow chart shown in FIG. 5 in the standby state, the standby state may be switched to the power supply ON state at a time point of starting an operation of a step S20.

When the operation of the flow chart shown in FIG. 5 is started, the system controller 25 determines whether the Apple TV2 is inserted into the insertion portion 106 or not (step S 10). As a determination method, a method is conceivable, in which it is determined that the Apple TV2 is inserted into the insertion portion 106 in a case where the power supply voltage 5 V is supplied to the fourth signal line of the HDMI terminal 107 disposed on the insertion portion 106. Besides, a method is also conceivable, in which the system controller 25 uses a CEC command to interrogate a source device connected to the HDMI terminal 107 disposed on the insertion portion 106 whether it is the Apple TV or not and in a case where there is a response to the interrogation, it is determined that the Apple TV2 is inserted into the insertion portion 106; however, the Apple TV2 must have the specification to be compatible with the CEC command for interrogating whether the Apple TV2 is the Apple TV or not. Besides, a method is also conceivable, in which the insertion portion 106 is provided with a touch switch that is turned on when the Apple TV2 is inserted into the insertion portion 106 and in a case where the touch switch is turned on, it is determined that the Apple TV2 is inserted into the insertion portion 106. It goes without saying that a method other than the above-described methods may be used to perform the determination.

In a case where the Apple TV2 is not inserted in the insertion portion 106 (NO in the step S10), the system controller 25 continuously executes the determination in the step S10.

On the other hand, in a case where it is determined that the Apple TV2 is inserted into the insertion portion 106 (YES in the step S10), the system controller 25 sets the “HDMI 3” as the “input target” (step S20). The Apple TV2 begins the startup after being inserted into the insertion portion 106; accordingly, there is a risk that the display screen 103 turns into a black display screen from a time when the process of the step S20 is executed to a time when the Apple TV2 completes the startup and an uncomfortable feeling is given to the user. Accordingly, it is desirable that upon executing the process of the step S20, the system controller 25 outputs the OSD control signal to the OSD display circuit 27 to turn the display screen 103 into, for example, an OSD display screen as shown in FIG. 7, thereafter, upon detecting that the signal processing circuit 14 receives the sound-video data from the Apple TV2, stops the output of the OSD control signal to prevent the OSD display from being superposed onto the video that is based on the video data from the Apple TV2.

In a step S30 that follows the step S20, the system controller 25 determines whether the Apple TV2 is removed from the insertion portion 106 or not. As a determination method, a method is conceivable, in which for example, in a case where the supply of the power supply voltage 5 V to the fourth signal line of the HDMI terminal 107 disposed on the insertion portion 106 is stopped, it is determined that the Apple TV2 is removed from the insertion portion 106. Besides, a method is also conceivable, in which the insertion portion 106 is provided with a touch switch that is turned on when the Apple TV2 is inserted into the insertion portion 106 and in a case where the touch switch is switched from an ON state to an OFF state, it is determined that the Apple TV2 is removed from the insertion portion 106. It goes without saying that a method other than the above-described methods may be used to perform the determination.

In a case where it is determined that the Apple TV2 is not removed from the insertion portion 106 (NO in the step S30), the system controller 25 continuously executes the determination in the step S30.

On the other hand, in a case where it is determined that the Apple TV2 is removed from the insertion portion 106 (YES in the step S30), the system controller 25 changes the “input target” from the “HDMI 3” to another choice (step S40), thereafter, returns to the step S10. In the step S40, for example, the “input target” may be changed from the “HDMI 3” to a choice for a default (e.g., “digital terrestrial broadcasting”), besides, for example, the “input target” may also be changed from the “HDMI 3” to the “input target” that is set immediately before the Apple TV2 is inserted into the insertion portion 106. Information of the choice for the default or information of the “input target” that is set immediately before the Apple TV2 is inserted into the insertion portion 106 may be stored in the memory 26.

Because of the above-described operation, in the video display apparatus 1 according to the embodiment of the present invention, when the Apple TV2 is inserted into the insertion portion 106, the “input target” is automatically switched to the “HDMI 3” and the video based on the video stream transmitted from the Apple TV2 is displayable; accordingly, it is not time-consuming to switch the input to the Apple TV2.

In the meantime, in the above-described embodiment, the specific external device, which is inserted into the insertion portion of the video display apparatus according to the present invention, is the Apple TV; however, devices (e.g., set top box and the like) other than the Apple TV may be used.

Besides, in the above-described embodiment, the insertion portion into which the specific external device is inserted is disposed in the front lower portion of the video display apparatus according to the present invention; however, another position (e.g., side surface, upper surface or the like) may be used.

Besides, in the above-described embodiment, the video stream is transmitted from the specific external device to the video display apparatus according to the present invention via the HDMI; however, the video stream may be transmitted from the specific external device to the video display apparatus according to the present invention via an interface other than the HDMI.

Besides, in the above-described embodiment, the insertion portion of the video display apparatus according to the present invention is provided with the AC power supply terminal; however, in a case where the specific external device is a device that is drivable even if the AC power supply voltage is not supplied, the AC power supply may not be disposed. Besides, in a case where the specific external device is a device that is driven on a DC power supply voltage and the specific external device cannot be driven on a DC power supply voltage (e.g., power supply voltage 5 V of the HDMI) that is suppliable via the interface for the video stream transmission, the insertion portion of the video display apparatus according to the present invention may be provided with a DC power supply terminal instead of the AC power supply terminal

### REFERENCE SIGNS LIST

1 video display apparatus according to an embodiment of the present invention
2 Apple TV
11 tuner/descrambler
12 DEMUX circuit
13 AV decoder
14 signal processing circuit
15 input switching circuit
16 video processing circuit
17 scaler
18 complex circuit
19 video output circuit
20 display
21 sound processing circuit
22 sound output circuit
23 speaker
24 remote control light receiver
25 system controller
26 memory
27 OSD display circuit
28 internet processing circuit
29 remote control transmitter
30 internet
31 main CPU
32 sub-CPU
33 wireless communication portion
34 Ethernet communication portion
35 remote control light receiver
36 video sound processing portion
101 operation portion
102 terminal portion
103 display screen
104 light reception surface
105 power supply lamp
106 insertion portion
107 HDMI terminal
108 AC power supply terminal
201 HDMI port
202 AC power supply port
203 Ethernet port
204 optical digital sound port

1. An video display apparatus comprising:
an insertion portion that enables direct insertion of a specific external device that outputs an video stream, and
a control portion, wherein
the insertion portion is provided with an input terminal for inputting the video stream output from the specific external device;
as choices for an “input target,” a plurality of choices including a choice corresponding to the input terminal are included; and
when the specific external device is inserted into the insertion portion, the control portion sets the choice corresponding to the input terminal as the “input target.”

2. The video display apparatus according to claim 1, wherein
when the specific external device is removed from the insertion portion, the control portion switches the setting of the “input target” from the choice corresponding to the input terminal to a choice other than the choice corresponding to the input terminal.

3. The video display apparatus according to claim 1, wherein
the video stream is transmitted from the specific external device to the video display apparatus via HDMI.

4. The video display apparatus according to claim 3, wherein
it is determined by using the HDMI whether the specific external device is inserted into the insertion portion or not.

5. The video display apparatus according to claim 1, wherein
the insertion portion is provided with a AC power supply terminal for supplying an AC power supply voltage to the specific external device.

6. The video display apparatus according to claim 1, wherein
when the control portion sets the choice corresponding to the input terminal as the “input target” in accordance with the insertion of the specific external device into the insertion portion, the control portion starts an message display, thereafter, upon detecting that outputting of the video stream from the specific external device is started, ends the message display.
